(19) United States
(12) Patent Application Publication
(10) Pub. No.: US 2020/0141771 A1
(43) Pub. Date: May 7, 2020

(54) VISION SYSTEM FOR UNMANNED AERIAL VEHICLE, AND UNMANNED AERIAL VEHICLE

(71) Applicant: SZ DJI TECHNOLOGY CO., LTD., Shenzhen (CN)

(72) Inventors: Wei WANG, Shenzhen (CN); Jiangang FENG, Shenzhen (CN)

(21) Appl. No.: 16/715,673

(22) Filed: Dec. 16, 2019

Related U.S. Application Data
(63) Continuation of application No. PCT/CN2017/102807, filed on Sep. 21, 2017.

(30) Foreign Application Priority Data
Jul. 28, 2017 (CN) 201720937290.1

(51) Int. Cl. G01D 11/30; B64C 39/02; G01D 11/24

(52) U.S. Cl. CPC G01D 11/30; G01D 11/245; B64C 39/024

(57) ABSTRACT

Embodiments of the present disclosure provide an unmanned aerial vehicle (UAV) vision system. The vision system includes a mounting base, the mounting base including a first positioning fixing structure; a vision support fixed to the mounting base; two vision sensors mounted on the vision support; two windows disposed on the mounting base; and an elastic washer disposed between an annular slot being formed between the first positioning fixing structure and a second positioning fixing structure. The vision support is configured to fix the two vision sensors, the two vision sensors are respectively exposed from the two windows. The vision support includes the second positioning fixing structure, and the second positioning fixing structure fits with the first positioning fixing structure.

### CROSS-REFERENCE TO RELATED APPLICATION

This application is a continuation application of International Application No. PCT/CN2017/102807, filed on Sep. 21, 2017, which claims priority to Chinese Application No. 201720937290.1, filed on Jul. 28, 2017, the entire contents of both of which are incorporated herein by reference.

### TECHNICAL FIELD

The present disclosure relates to the field of flight technology, and more specifically, to an unmanned aerial vehicle (UAV) and a vision system thereof.

### BACKGROUND

In conventional technology, the vision system of an UAV is generally fixed on the body through a vision support. However, the assembly and positioning accuracy of the current vision system is not ideal, resulting in unsatisfactory visual effects.

### SUMMARY

One aspect of the present disclosure provides an unmanned aerial vehicle (UAV) vision system. The vision system includes a mounting base, the mounting base including a first positioning fixing structure; a vision support fixed to the mounting base; two vision sensors mounted on the vision support; two windows disposed on the mounting base; and an elastic washer disposed between an annular slot being formed between the first positioning fixing structure and a second positioning fixing structure. The vision support is configured to fix the two vision sensors, the two vision sensors are respectively exposed from the two windows. The vision support includes the second positioning fixing structure, and the second positioning fixing structure fits with the first positioning fixing structure.

Another aspect of the present disclosure provides an unmanned aerial vehicle (UAV) including an upper housing and a vision system. The vision system includes a mounting base, the mounting base including a first positioning fixing structure; a vision support fixed to the mounting base; two vision sensors mounted on the vision support; two windows disposed on the mounting base; and an elastic washer disposed between an annular slot being formed between the first positioning fixing structure and a second positioning fixing structure. The vision support is configured to fix the two vision sensors, the two vision sensors are respectively exposed from the two windows. The vision support includes the second positioning fixing structure, and the second positioning fixing structure fits with the first positioning fixing structure. The upper housing and the mounting base form a body of the UAV, and the vision system is fixedly mounted in the body.

In embodiments of the present disclosure, an elastic washer is compressed in an annular slot such that the mounting precision between the first positioning fixing structure and the second positioning fixing structure can be improved. As such, the assembly tolerance of the first positioning fixing structure and the second positioning fixing structure can be increased, the machining accuracy requirement of the two positioning fixing structures can be reduced, and the assembly precision between the first positioning fixing structure and the second positioning fixing structure can be effectively ensured while reducing the machining precision requirement, thereby improving the yield rate and the cost of the vision system of the UAV.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a perspective view of a vision system of a UAV according to an embodiment of the present disclosure.

FIG. 2 is a cross-sectional view of the vision system of the UAV according to an embodiment of the present disclosure.

FIG. 3 is an exploded perspective view of the vision system of the UAV according to an embodiment of the present disclosure.

FIG. 4 is another exploded perspective view of the vision system of the UAV according to an embodiment of the present disclosure.

FIG. 5 is a cross-sectional view illustrating a first positioning fixing structure and a second positioning fixing structure of the vision system of the UAV according to an embodiment of the present disclosure.

FIG. 6 is a perspective view of the UAV according to an embodiment of the present disclosure.

FIG. 7 is an exploded perspective view of the UAV according to an embodiment of the present disclosure.

### DESCRIPTION OF THE REFERENCE NUMERALS

100 UAV
10 Vision system
101 Fastener
11 First positioning fixing structure
111 Fixing post
112 Fixing hole
113 Reinforcing plate
12 Mounting base
121 Window
122 Side plate
123 Bottom plate
124 Receiving groove
125 Receiving cavity
14 Vision support
141 Support body
142 Suspension arm
15 Second positioning fixing structure
151 Positioning cap
152 Through hole
153 Through groove
16 Vision sensor
17 Stiffener structure
171 Stiffener
18 Elastic washer
20 Upper housing
30 Body

### DETAILED DESCRIPTION OF THE EMBODIMENTS

The embodiments of the present disclosure will be described below. Examples of the embodiments are shown in the accompanying drawings, in which the same or similar umbers refer to the same or similar elements unless otherwise specified. It will be appreciated that the described embodiments shown in the drawings are illustrative, are only described to explain the present disclosure, and cannot be interpreted as being limiting the scope of the present disclosure.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom”, “inner”, “outer”, “clockwise”, “anticlockwise” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

As used herein, unless there is express definition or limitation, the term “mount,” “couple,” or “connect” should be construed broadly. For example, they may include fixed connection, detachable connection, or integral connection. They may include mechanical connection, electrical connection, or communicative connection. They may include direct connection or connection through an intermediate medium. They may include connection between two elements or an interactive relationship between two elements. A person having ordinary skills in the art can interpret the meaning of the terms in the present disclosure based on specific context.

In the description of the present disclosure, a structure in which a first feature is “on” a second feature may include an embodiment in which the first feature directly contacts the second feature, and may also include an embodiment in which an additional feature is formed between the first feature and the second feature so that the first feature does not directly contact the second feature, unless otherwise specified. Furthermore, a first feature “on,” “above,” or “on top of” a second feature may include an embodiment in which the first feature is right “on,” “above,” or “on top of” the second feature, and may also include an embodiment in which the first feature is not right “on,” “above,” or “on top of” the second feature, or just means that the first feature has a sea level elevation larger than the sea level elevation of the second feature. While first feature “beneath,” “below,” or “on bottom of” a second feature may include an embodiment in which the first feature is right “beneath,” “below,” or “on bottom of” the second feature, and may also include an embodiment in which the first feature is not right “beneath,” “below,” or “on bottom of” the second feature, or just means that the first feature has a sea level elevation smaller than the sea level elevation of the second feature.

The present disclosure provides various different embodiments or examples for realizing the different structures of the present disclosure. To simplify the descriptions, next, the components and configurations of specific examples will be described. These descriptions are only for illustrative purposes, and do not limit the scope of the present disclosure. In addition, reference numbers and/or reference alphabets may be repeatedly used in different examples. Such repetition is for the purpose of simplification and clarity, and does not necessarily imply any relationship between the various embodiments and/or configurations. Moreover, the present disclosure provides examples of the specific processes and materials. A person having ordinary skills in the art can appreciate that other processes and/or other materials may also be used.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

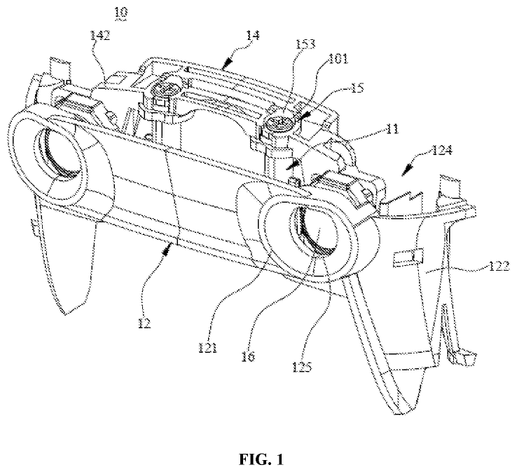

Referring to FIGS. 1-5, a vision system 10 of a UAV 100 of an embodiment of the present disclosure includes a mounting base 12, a vision support 14, two vision sensors 16, and an elastic washer 18.

The mounting base 12 includes a first positioning fixing structure 11, the vision support is fixed to the mounting base 12, and the two vision sensors 16 are mounted on the vision support 14. The vision support 14 may be used to support the two vision sensors 16. Two windows 121 are disposed on the mounting base 12, and the two vision sensors 16 are exposed from the two windows 121, respectively. The vision support 14 includes a second positioning fixing structure 15 that mates with the first positioning fixing structure 11. An annular slot is formed between the first positioning fixing structure 11 and the second positioning fixing structure 15, and the elastic washer 18 is disposed in the annular slot.

In the visual system 10 of the UAV describe above, the elastic washer 18 is compressed in the annular slot such that the mounting precision between the first positioning fixing structure 11 and the second positioning fixing structure 15 can be improved. As such, the assembly tolerance of the first positioning fixing structure 11 and the second positioning fixing structure 15 can be increased, the machining accuracy requirement of the two positioning fixing structures can be reduced, and the assembly precision between the first positioning fixing structure 11 and the second positioning fixing structure 15 can be effectively ensured while reducing the machining precision, thereby improving the yield rate and the cost of the vision system of the UAV.

It should be noted that the two vision sensors 16 may be used for visual positioning. For example, when an obstacle is identified in the flight direction of the UAV 100, an alert, which may include a distance reminder, may be sent to the user.

In addition, the two vision sensors 16 can be electrically connected to a body 30 of the UAV via a flexible circuit board. The two vision sensors 16 can be mounted on the vision support 14 by glue. The performance of the glue can be considered from the aspect of hardness, viscosity, shrinkage rate, and linear shrinkage to ensure the fixation accuracy of the two vision sensors 16. Of course, it can be understood that the two vision sensors 16 can be fixed to the vision support 14 by other fixing means, for example, by screw fixing, welding, structural limitation, or the like.

In some embodiments, the mounting base 12 can be made of a plastic part or a magnesium alloy die-casting part, such that the mounting base 12 can be light in weight.

Of course, it can be understood that the material used for the mounting base 12 can be set as needed and is not limited to the materials listed above.

In some embodiments, the vision support 14 can be made of a metal material and formed by die casting. As such, the vision support 14 may have a better dimensional accuracy and the manufacturing process may be relatively simple.

In some embodiments, he first positioning fixing structure 11 and the second positioning fixing structure 15 can be formed by using computer numerical control (CNC) machine. As such, the two positioning fixing structures may have a better dimensional accuracy.

In some embodiments, the vision system 10 may include a fastener 101. The fastener 101 may pass through the second positioning fixing structure 15 and fixed on the first positioning fixing structure 11 to fix the vision support 14 to the mounting base 12. As such, the positioning of the two positioning fixing structures may be relatively simple, and the stability may be improved.

It should be noted that the elastic washer 18 may also provide a shock absorbing effect. When the UAV 100 having the vision system 10 is in operation, the vibration of the body 30 of the UAV 100 can may applied to the fastener 101 through the mounting base 12, and the vibration of the fastener 101 may be converted into an elastic deformation of the elastic washer 18. As such, the vibration of the body of the UAV 100 may be effectively buffered, thereby ensuring the detection accuracy of the two vision sensors 16.

It can be understood that if a plurality of elastic washers 18 are disposed in the annular slot, the shock absorbing effect may be further improved.

In some embodiments, the elastic washer 18 may be a silicon pad. Of course, it can be understood that in other embodiments, other elastic materials such as rubber materials may also be used for the elastic washer 18.

In some embodiments, the first positioning fixing structure 11 may include a fixing post 111, and the fixing post 111 may be disposed in a fixing hole 112. The second positioning fixing structure 15 may include a positioning cap 151 sleeved on the fixing post 111. A through hole 152 may be disposed in the positioning cap 151 that may be in communication with the fixing hole 112. The fixing hole 112 may be coaxial with the through hole 152. The fastener 101 may be threaded through the through hole 151 is and fixed in the fixing hole 112. In addition, the elastic washer 18 may be housed in the positioning cap 151. As such, the elastic washer may be sufficiently filled between the fixing post 111 and the positioning cap 151 to achieve a soft contact between the fixing post 111 and the positioning cap 151, thereby ensuring better matching precision between the fixing post 111 and the positioning cap 151.

In some embodiments, a through groove 153 may be disposed on an upper end of the second positioning fixing structure 15. The through groove 153 may be in communication with the through hole 152. The fastener 101 may be sequentially inserted through the through groove 153 and the through hole 152, and fixed in the fixing hole 112. In addition, an upper end of the fastener 101 may be housed in the through groove 153. As such, the arrangement of the through groove 153 may improve the stability of the installation of the fastener 101.

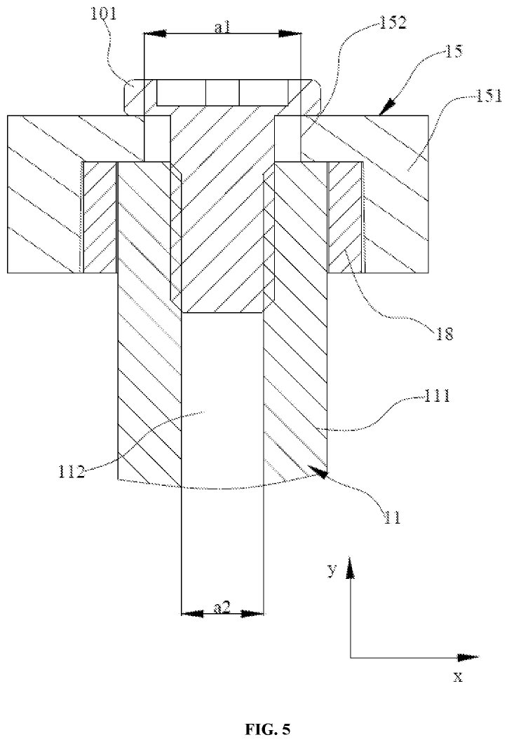

In some embodiments, a gap may be left between the fastener 101 and an inner wall of the through hole 152. As such, the fastener 101 may have a flexible motion space in both the x and y directions (as shown in FIG. 5), thereby cushioning the force and further improving the shock absorption effect of the vision system 10.

Referring to FIG. 5, in this embodiment, an aperture a1 of the through hole 152 may be larger than an aperture a2 of the fixing hole. In some embodiments, a gap may be left between the fastener 101 and an inner wall of the through hole 152. As such, the lower portion of the fastener 101 may be stably fixed in the fixing hole 112, and a sufficient gap margin may be left between the upper portion of the fastener 101 and the inner wall of the through hole 152.

Of course, it can be understood that in other embodiments, the vision system 10 may also include an elastic ring (not shown) disposed between the fastener 101 and the positioning cap 151. The ring may be disposed inside the through hole 152, and the fastener 101 may thread through the ring. The ring may separate the fastener 101 from the inner wall of the through hole 152. As such, the ring may also be used to provide a flexible motion space in both the x and y directions (as shown in FIG. 5), thereby cushioning the force. In some embodiments, the ring may be made of a silicone material and compressively disposed between the fastener 101 and the positioning cap 151.

In some embodiments, the fastener may be a bolt, and the fixing hole 112 may be a screw hole. As such, the fastener 101 may be more stable when the fastener 101 is fixed in the fixing hole 112, and the fastener 101 may be relative generic, which may have a lower manufacturing cost.

In some embodiments, the vision system 10 may include two fixing posts 111, and the two fixing posts 111 may be spaced and arranged in parallel. Further, the number of the positioning caps 151 may be the same as the number of the fixing posts 111. As such, the parallelism and stability of the vision support 14 to the mounting base may be improved, thereby providing better positioning and parallelism between the two vision sensors 16.

It should be noted that the number of the fixing posts 111 is not limited to two, and the number of the fixing posts 111 may be three, four, five, etc. The number of the fixing posts 111 may be set based on specific conditions, and is not limited in the present disclosure.

In some embodiments, the vision support 14 may be formed with a Stiffener structure 17 that connects the second positioning fixing structure 15. The Stiffener structure 17 may include a plurality of Stiffeners 171 that are spaced apart. As such, the arrangement of the plurality of Stiffeners 171 may improve the structural strength of the vision support 14, and ensure the second positioning fixing structure 15 has better structural stability.

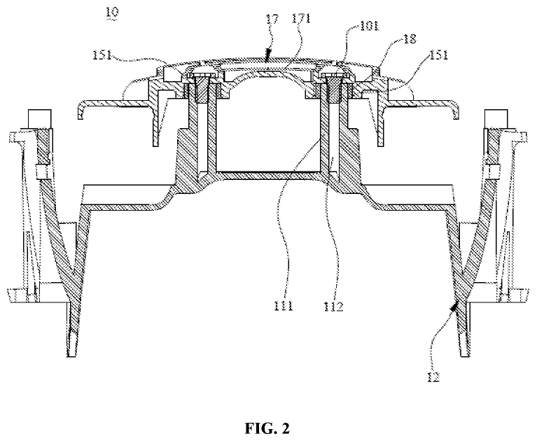

Referring to FIG. 1 and FIG. 2, in this embodiment, the second positioning fixing structure 15 includes two positioning caps 151. The two positioning caps 151 are spaced apart and arranged in parallel, and a plurality of Stiffeners 171 are connected to the two positioning caps 151.

In some embodiments, the mounting base 12 may include a plurality of side plates 122 and a bottom plate 123 that may be connected end to end. A receiving groove 124 for receiving and installing the vision support 14 may be formed between the plurality of side plates 122 and the bottom plate 123. In some embodiments, two windows 121 that are spaced apart may be formed on one of the plurality of side plates 122, and the fixing post 111 may extend upward from the bottom plate 123 and be disposed between the two windows 121. As such, the vision support 14 may be housed in the receiving groove 124, such that the mounting base 12 may protect the two vision sensors 16. In addition, since the fixing post 111 is disposed between the two windows 121, after the fixing post 111 is closely fitted with the positioning cap 151, the fastener 101, and the elastic washer 18, the two vision sensors 16 may have a better parallelism.

It can be understood that to prevent the mounting base 12 from affecting the detection accuracy of the two vision sensors 16, a gap may be left between the two vision sensors 16 and the inner wall of the receiving groove 124. As such, when the body 30 of the UAV 100 vibrates during the flight of the UAV 100, the vibration of the mounting base 12 may not be directly transmitted to the two vision sensors 16 through the inner wall of the receiving groove 124, thereby preventing the mounting base 12 from affecting the detection accuracy of the two vision sensors 16.

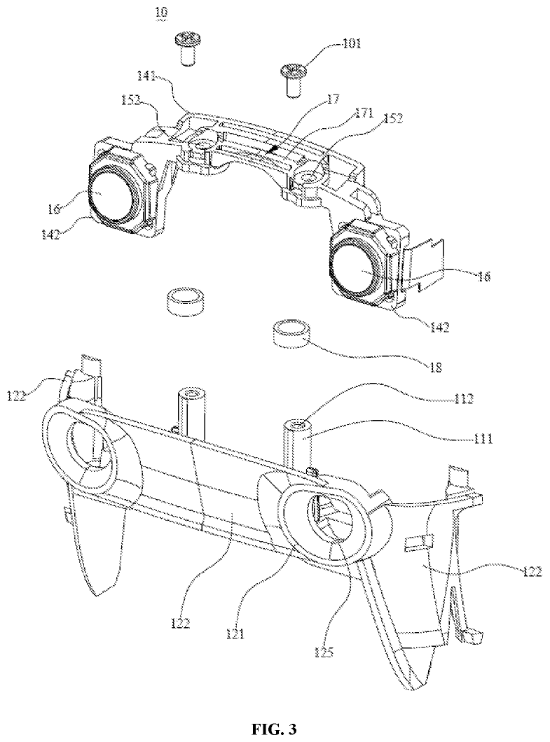

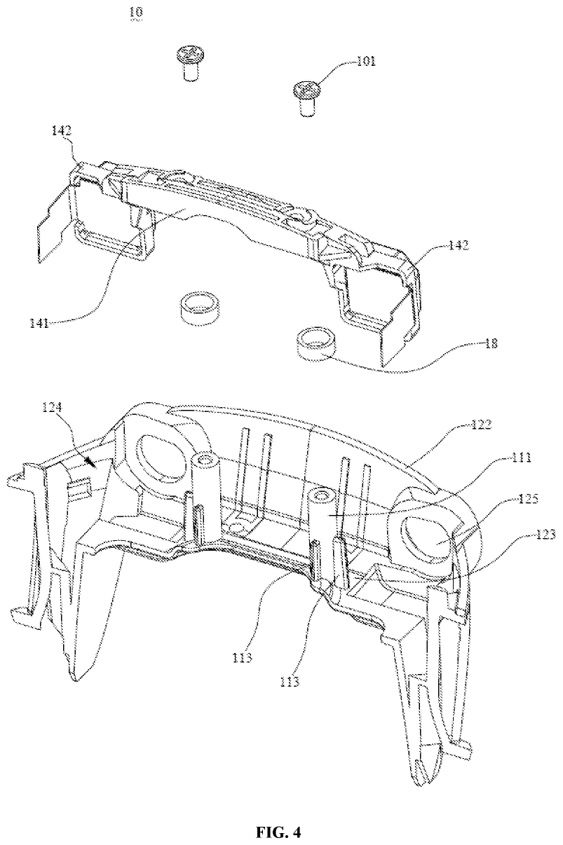

Referring to FIG. 3 and FIG. 4, in this embodiment, the two vision sensors 16 are mounted on the side plate 122 that may be used as front panels. Two windows 121 and receiving cavities 125 that are spaced apart may be disposed on the side plate 122. Each receiving cavity 125 may be connected to a corresponding window 121, each vision sensor 16 may be housed in a corresponding receiving cavity 125, and a gap may be left between each vision sensor 16 and the inner wall of the receiving cavity 125. As such, the receiving cavities 125 may also serve to protect the vision sensors 16.

In some embodiments, the vision support 14 may include a support body 141 and two suspension arms 142 connected to both sides of the support body 141. The second positioning fixing structure 15 may be disposed on the support body 141. Each of the suspension arms 142 may extend outward and downward from an end of the support body 141. In addition, the two vision sensors 16 may be secured to the free ends of the two suspension arms 142, respectively. As such, the positioning and parallelism of the two vision sensors 16 may be improved.

It can be understood that in order to further improve the shock absorption effect, a gap may be left between each of the suspension arms 142 and the bottom plate 123, and a gap may be left between each of the suspension arms 142 and the side plate 122. As such, the vision support 14 may be suspended in the receiving groove 124, which may further reduce the probability of the shock being transmitted by the mounting base 12 to the two vision sensors 16.

In the example shown in FIG. 4, the first positioning fixing structure 11 includes a plurality of reinforcing plates 113 extending outward from an outer surface of the bottom of the fixing post 111, and the plurality of reinforcing plates 113 are spaced apart. Each reinforcing plate may be connected to the bottom plate 123. As such, the arrangement of the plurality of reinforcing plates 123 can increase the structural strength of the bottom of the fixing post 111, such that the structural stability of the vision support 14 fixed to the mounting base 12 can be further improved.

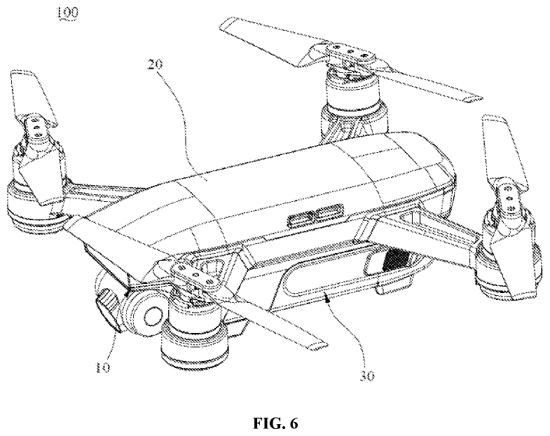

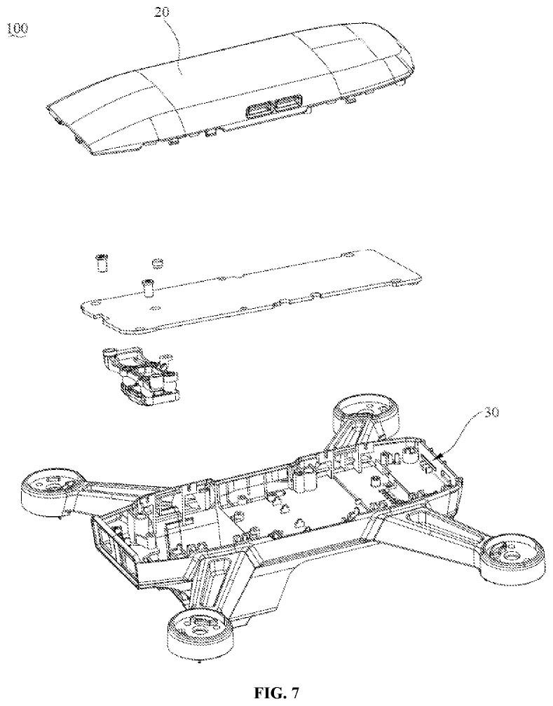

Referring to FIG. 6 and FIG. 7, the UAV 100 of the embodiment of the present disclosure includes an upper housing 20 and a vision system 10 according to any of the embodiments described above. The upper housing 20 and the mounting base 12 may form the body 30 of the UAV 100. The vision system 10 may be fixedly mounted within the body 30.

In the UAV 100 of the embodiment of the present disclosure, the elastic washer 18 is compressed in the annular slot such that the mounting precision between the first positioning fixing structure 11 and the second positioning fixing structure 15 can be improved. As such, the assembly tolerance of the first positioning fixing structure 11 and the second positioning fixing structure 15 can be increased, the machining accuracy requirement of the two positioning fixing structures can be reduced, and the assembly precision between the first positioning fixing structure 11 and the second positioning fixing structure 15 can be effectively ensured while reducing the machining precision, thereby improving the yield rate and the cost of the vision system of the UAV.

In the descriptions, terms such as “an embodiment,” “some embodiments,” “example embodiments,” “example,” “illustration,” or “specific example,” or “some examples,” are used to describe that the feature, structure, material, or characteristics may include at least one example or embodiment. In the descriptions, the use of the illustrative expressions does not necessarily indicate that the implementation methods or examples are the same. In addition, the specific feature, structure, material, or characteristics may be combined in any suitable manner in one or more embodiment.

The above shows and describes various embodiments of the present disclosure. It is understood that these embodiments are illustrative, and should not be construed to limit the scope of the present disclosure. A person having ordinary skills in the art can change, modify, replace, or make variations of the various embodiments within the scope of the present disclosure. Such changes, modifications, replacements, or variations all fall within the scope of the present disclosure.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. An unmanned aerial vehicle (UAV) vision system, comprising:
a mounting base, the mounting base including a first positioning fixing structure;
a vision support fixed to the mounting base;
two vision sensors mounted on the vision support;
two windows disposed on the mounting base; and
an elastic washer disposed between an annular slot being formed between the first positioning fixing structure and a second positioning fixing structure, wherein
the vision support is configured to fix the two vision sensors, the two vision sensors are respectively exposed from the two windows, the vision support includes the second positioning fixing structure, and the second positioning fixing structure fits with the first positioning fixing structure.

2. The UAV vision system of claim 1, further includes:
a fastener arranged to pass through the second positioning fixing structure and being fixed in the first positioning fixing structure to fix the vision support on the mounting base.

3. The UAV vision system of claim 2, wherein the first positioning fixing structure includes a fixing post with a fixing hole, the second positioning fixing structure includes a positioning cap sleeved placed on the fixing post and the positioning cap having a through hole, the fixing hole being coaxial with the through hole, the fastener goes through the through hole and is fixed in the fixing hole, and the elastic washer is housed in the positioning cap.

4. The UAV vision system of claim 3, wherein a gap is formed between the fastener and an inner wall of the through hole.

5. The UAV vision system of claim 3, wherein the fastener is a bolt and the fixing hole is a screw hole.

6. The UAV vision system of claim 3, wherein the number of the fixing post is two, the two fixing posts being spaced apart and arranged in parallel, and the number of the positioning caps is the same as the number of the fixing posts.

7. The UAV vision system of claim 1, wherein the vision support includes a Stiffener structure connecting the second positioning fixing structure, and the Stiffener structure includes a plurality of ribs being spaced apart.

8. The UAV vision system of claim 3, wherein the mounting base includes a plurality of side plates respectively connected and a bottom plate, and a receiving groove arranged to receive and mount the vision support formed between the plurality of side plates and the bottom plate; one of the plurality of side plates includes the two windows being spaced apart; and the fixing post extends upward from the bottom plate and is positioned between the two windows.

9. The UAV vision system of claim 8, wherein the vision support includes a support body and two suspension arms connected to two sides of the support body, the second positioning fixing structure being arranged on the support body, each of the suspension arms extending outward and downward from an end of the support body, and the two vision sensors are respectively fixed to free ends of the two suspension arms.

10. An unmanned aerial vehicle (UAV) including an upper housing and a vision system, the vision system comprising:
a mounting base, the mounting base including a first positioning fixing structure;
a vision support fixed to the mounting base;
two vision sensors mounted on the vision support;
two windows disposed on the mounting base; and
an elastic washer disposed between an annular slot being formed between the first positioning fixing structure and a second positioning fixing structure, wherein
the vision support is used to fix the two vision sensors, the two vision sensors are respectively exposed from the two windows, the vision support includes the second positioning fixing structure, the second positioning fixing structure fits with the first positioning fixing structure, the upper housing and the mounting base form a body of the UAV, and the vision system is fixedly mounted in the body.

11. The UAV of claim 10, wherein the vision system further includes a fastener arranged to pass through the second positioning fixing structure and being fixed in the first positioning fixing structure to fix the vision support on the mounting base.

12. The UAV of claim 11, wherein the first positioning fixing structure includes a fixing post with a fixing hole, the second positioning fixing structure includes a positioning cap sleeved placed on the fixing post and the positioning cap having a through hole, the fixing hole being coaxial with the through hole, the fastener goes through the through hole and is fixed in the fixing hole, and the elastic washer is housed in the positioning cap.

13. The UAV of claim 12, wherein a gap is formed between the fastener and an inner wall of the through hole.

14. The UAV of claim 12, wherein the fastener is a bolt and the fixing hole is a screw hole.

15. The UAV of claim 12, wherein the number of the fixing post is two, the two fixing posts being spaced apart and arranged in parallel, and the number of the positioning caps is the same as the number of the fixing posts.

16. The UAV of claim 10, wherein the vision support includes a Stiffener structure connecting the second positioning fixing structure, and the Stiffener structure includes a plurality of ribs being spaced apart.

17. The UAV of claim 12, wherein the mounting base includes a plurality of side plates and a bottom plate respectively connected end to end, and a receiving groove arranged to receive and mount the vision support formed between the plurality of side plates and the bottom plate; one of the plurality of side plates includes the two windows being space apart; and the fixing post extends upward from the bottom plate and is positioned between the two windows.

18. The UAV of claim 17, wherein the vision support includes a support body and two suspension arms connected to two sides of the support body, the second positioning fixing structure being arranged on the support body, each of the suspension arms extending outward and downward from an end of the support body, and the two vision sensors are respectively fixed to free ends of the two suspension arms.
